(19) United States
(12) Patent Application Publication
(10) Pub. No.: US 2011/0021803 A1
(43) Pub. Date: Jan. 27, 2011

(54) PURIFICATION AND PREPARATION OF PHOSPHORUS-CONTAINING COMPOUNDS

(76) Inventors: Wiechang Jin, Madison, WI (US); Xiaohong Chen, Kohler, WI (US)

Correspondence Address: HARNESS, DICKEY, & PIERCE, P.L.C, 7700 Bonhomme, Suite 400, ST. LOUIS, MO, 63105, US

(21) Appl. No.: 12/921,421

(22) PCT Filed: Mar. 19, 2009
(86) PCT No.: PCT/US09/37674

§ 371 Date: Oct. 12, 2010

Related U.S. Application Data
(60) Provisional application No. 61/038,291, filed on Mar. 20, 2008.

(51) Int. Cl. C07F 9/09

(52) U.S. Cl. 558/150

(57) ABSTRACT

A phosphorus-containing compound is treated with at least one metal compound prior to fractional distillation to collect a purified fraction containing about 20 ppb or less arsenic. The purified phosphorus-containing compounds are useful for preparing electronic materials for electronic semiconductor manufacturing. Suitable metal compounds include salts, oxides and/or sulfides of iron, copper, nickel, cobalt, or zinc.

### CROSS-REFERENCE TO RELATED APPLICATIONS

This patent claims priority to U.S. provisional patent application Ser. No. 61/038,291 filed on 20 Mar. 2008, the disclosure of which is incorporated by reference in its entirety.

### FIELD OF THE INVENTION

The present disclosure relates to preparation and purification of phosphorus-containing compounds. In particular, the disclosure provides methods of removing arsenic from phosphorus-containing compounds and collecting purified fractions by distillation.

### BACKGROUND OF THE INVENTION

Arsenic and phosphorus share some chemical properties, the recognition of which is acknowledged by their being classified in the same group of the periodic table. One consequence of the chemical similarity is the observation that the elements coexist in ores such that any natural material that is a good commercial source of phosphorus contains at least trace levels of arsenic. As a result of the co-occurrence in ores, compounds made from the ores, such as certain phosphorus-containing compounds, necessarily carry at least trace levels of arsenic. And because of the noted chemical similarity, it is often difficult to separate the arsenic from the phosphorus-containing compounds. The contamination of phosphorus-containing compounds by arsenic can be tolerated if the end use of the phosphorus-containing compound is not sensitive to the presence of arsenic. In some cases, however, it is desired to produce phosphorus-containing compounds, such as organophosphorus compounds of higher purity and characterized by very low levels of arsenic.

For example, in the semiconductor manufacturing process, phosphorus-containing compounds are often used as dopants at layers near the transistor or gate level. In such applications, certain impurities present at the concentration even of a few atoms per square centimeter can affect the performance and/or lifetime of a transistor on a microchip. In these cases, the purity requirements of the precursor material with respect to metal impurities are stringent.

Products such as triethyl phosphate (TEPO) and trimethyl phosphate (TMPO) are used in semiconductor chip manufacturing. In particular, TEPO is one of three key ingredients used in making borophosphosilicate glass films for the chip manufacturing process. It has been found desirable to limit the amount of arsenic in TEPO to as low as 20 parts per billion (ppb) or lower for these applications.

While processes such as semiconductor chip manufacturing require an arsenic level at or below about 20 ppb, commercially available phosphorus-containing compounds, such as TEPO, tend to show a relatively high level of arsenic contamination from a few hundred ppb down to about 40 ppb. Because of the similarity in chemical and physical properties, separation of arsenic contaminants from phosphorus-containing compounds to a ppb level is a non-trivial technical challenge. In particular, it has been observed that distillation is not effective if the arsenic level is too high.

Thus, there is a continued need for sources of phosphorus-containing compounds containing a low arsenic level and for methods of purifying known sources of phosphorus-containing compounds to provide a lower arsenic level, for example at or below 20 ppb.

### SUMMARY OF THE INVENTION

In one embodiment, a method of purifying a starting material, wherein the starting material is a phosphorus-containing compound having arsenic contaminate, is provided. The method comprises: contacting the starting material with at least one metal compound to provide a mixture; then fractionally distilling the mixture to provide at least two distillation fractions; and collecting at least one distillation fraction containing a phosphorus-containing compound having less arsenic contaminate than the starting material.

In another embodiment, a method of purifying a starting material, wherein the starting material is an arsenic-contaminated phosphorus-containing compound is provided. The method comprises: refluxing the starting material in the presence of at least one metal compound to provide a reflux mixture; whereby a phosphorus-containing compound having lower arsenic contamination than the starting material may be separated from the reflux mixture by fractional distillation.

In another embodiment, a method of purifying a phosphorus-containing compound having greater than about 20 ppb arsenic is provided, the method comprises:

refluxing the phosphorus-containing compound in the presence of at least one transition metal compound selected from the group consisting of iron salt, cobalt salt, nickel salt, copper salt, zinc salt, iron oxide and iron sulfide to provide a reflux mixture;

fractionally distilling the reflux mixture to collect a low boiling fraction as a forecut and a second fraction, wherein the second fraction is collected at the boiling point of the phosphorus-containing compound; and

isolating the second fraction and optionally combining it with other fractions to provide a phosphorus-containing compound having about 20 ppb or less arsenic.

In another embodiment, a method of reducing arsenic in a starting material, wherein the starting material is a phosphorus-containing compound, is provided. The method comprises: pre-treating the starting material with water to make a mixture; removing water from the mixture by combining the mixture with a drying agent; treating the mixture with a basic compound; and distilling the mixture to collect at least one distillation fraction that contains a phosphorus-containing compound having a lower arsenic than the starting material.

Further areas of applicability will become apparent from the description provided herein. It should be understood that the description and specific examples are intended for purposes of illustration only and are not intended to limit the scope of the present disclosure.

### DETAILED DESCRIPTION OF THE INVENTION

### A. Definitions

As used herein, the term “phosphorus-containing compound” refers to a compound containing a phosphorus derivative. A phosphorus derivative is phosphorus in an oxidized state. For example, the phosphorus derivative can have a lower valency, referred to as “phosphorous”. Such phosphorous compounds include +1 compounds, such as hypophosphorous acid and hypophosphite. Phosphorous compounds also include +3 compounds, such as phosphorous acid, phosphite, metaphosphorous acid and metaphosphite. Alternatively, the phosphorus derivative can have a higher valency, referred to as “phosphoric”. Such phosphoric compounds include +4 compounds, such as hypophosphoric acid and hypophosphate. Phosphoric compounds also include +5 compounds, such as phosphonate, phosphoric acid, phosphate, metaphosphate, and pyrophosphate.

The term “phosphorus-containing compound” includes both organophosphorus compounds and inorganophosphorus compounds.

Non-limiting examples of an organophosphorus compound include various phosphate and phosphonate esters, such as TEPO, TMPO, triisopropyl phosphate, tri-n-propyl phosphate, tributyl phosphate, dimethyl methylphosphonate, diethyl methylphosphonate, diisopropyl ethylphosphonate, dibutyl methylphosphonate, dimethyl ethylphosphonate, diethyl ethylphosphonate, diisopropyl ethylphosphonate, dibutyl methylphosphonate, and dibutyl ethylphosphonate.

Non-limiting examples of an inorganophosphorus compound include POCl₃, PCl₃, P₂O₅, P₂O₃ and H₃PO₄.

As used herein, the terms “purify”, “purified” and “pure” refer to any reduction in the level of arsenic contamination in one or more phosphorus-containing compounds. In one embodiment, a “purified” or “pure” phosphorus-containing compound has a lower level of arsenic contamination, that is, an arsenic level reduced to about 20 ppb or lower.

As used herein, “metal compound” refers to a transition or non-transition metal compound. A metal compound includes metal salts, metal sulfides, metal oxides, metal nitrides, metal clathrates, organometallic compounds, metal acetates, metal perchlorates, metal triflates, metal sulfates and metal phosphates. Further, the term compound can also include a “complex”. A “transition metal compound” includes, for example, those having iron, cobalt, nickel, copper or zinc. In a particular embodiment, a ferrous compound or cuprous compound is used. Further, non-limiting examples of transition metal compounds include ferrous sulfide, ferrous oxide, and cuprous chloride.

As used herein, the term “starting material” refers to a phosphorus-containing compound having arsenic contamination (also referred to as having an arsenic contaminate and/or arsenic-contaminated phosphorus-containing compound) and represents the compound to be purified by the methods disclosed herein.

As used herein, the term “arsenic” is intended to encompass arsenic in all of its available forms, such as, free metal (including all allotropic forms) and arsenic-containing organic and inorganic compounds, such as arsenide and arsenate compounds (including all oxidation states such as, but not limited to, −3, +1, +3 and +5). Examples of arsenic-containing compounds include, but are not limited to:

(1) arsenic oxides such as, but not limited to, As₂O₃ and As₂O₅; and

(2) arsenic sulfides such as, but not limited to, As₄S₃, As₄S₄, As₂S₃ and As₄S₁₀; and

(3) arsenic alkoxides such as, but not limited to, As(OMe)₃, As(OEt)₃, As(O-n-Pr)₃, As(O-i-Pr)₃, As(O-n-Bu)₃, As(O-sec-Bu)₃, As(O-t-Bu)₃, As(═O)(OMe)₃, As(═O)(OEt)₃, As(═O)(O-n-Pr)₃, As(═O)(O-n-Bu)₃, As(═O)(O-sec-Bu)₃ and As(═O)(O-t-Bu)₃; and

(4) hydrolysis products such as, but not limited to, As(═O)(OMe)₂(OH), As(═O)(OEt)₂(OH), As(═O)(O-n-Pr)₂(OH), As(═O)(O-n-Bu)₂(OH), As(═))(O-sec-Bu)₂(OH), As(═O)(O-t-Bu)₂(OH), As(═O)(OMe)(OH)₂, As(═O)(OEt)(OH)₂, As(═O)(O-n-Pr)₂(OH)₂, As(═O)(O-n-Bu)(OH)₂, As(═O)(O-sec-Bu)(OH)₂, As(═O)(O-t-Bu)(OH)₂, As(═O)(OH)₃, As(═O)Me(OMe)(OH), As(═O)Me(OEt)(OH), As(═O)Me(O-i-Pr)(OH), As(═O)Me(O-n-Pr)(OH), As(═O)Me(O-Bu)(OH), As(═O)Me(OH)₂, As(═O)Et(OMe)(OH), As(═O)Et(OEt)(OH), As(═O)Et(O-i-Pr)(OH), As(═O)Et(O-n-Pr)(OH), As(═O)Et(O-Bu)(OH), As(═O)Et(OH)₂, As(═O)Me₂(OMe), As(═O)Me₂(OEt), As(═O)Me₂(O-i-Pr), As(═O)Me₂(O-n-Pr), As(═O)Me₂(O-Bu), As(═O)Me₂(OH), As(═O)Et₂(OMe), As(═O)Et₂(OEt), As(═O)Et₂(O-i-Pr), As(═O)Et₂(O-n-Pr), As(═O)Et₂(O-Bu) and As(═O)Et₂(OH)₂; and

(5) arsenic alkyls and arsenic-oxide alkyls such as, but not limited to, As(Me)₃, As(Et)₃, As(n-Pr)₃, As(i-Pr)₃, As(n-Bu)₃, As(sec-Bu)₃, As(t-Bu)₃, As(═O)(Me)₃, As(═O)(Et)₃, As(═O)(n-Pr)₃, As(═O)(n-Bu)₃, As(═O)(sec-Bu)₃ and As(═O)(t-Bu)₃; and

(6) arsenic halides such as, but not limited to, AsCl₃, AsBr₃, As(═O)Cl₃ and As(═O)Br₃; and

(7) any arsenic-containing compounds which are structurally analogous to phosphorus-containing compounds such as, but not limited to, As(═O)Me(OMe)₂, As(═O)Me(OEt)₂, As(═O)Me(O-i-Pr)₂, As(═O)Me(O-n-Pr)₂, As(═O)Me(O-Bu)₂, As(═O)Et(OMe)₂, As(═O)Et(OEt)₂, As(═O)Et(O-i-Pr)₂, As(═O)Et(O-n-Pr)₂, As(═O)Et(O-Bu)₂, and any of the phosphorus-containing compounds listed in the above paragraphs.

Further, “arsenic contaminate” or “arsenic contamination” refers to the presence of arsenic, above about 20 ppb, in the phosphorus-containing material.

### B. Purification and Preparation Using Metal Compound(s)

In one embodiment, a method is provided of purifying a phosphorus-containing compound, such as an organophosphorus compound, that contains an undesirably high contaminate level of arsenic. The method involves first contacting a phosphorus-containing compound with at least one metal compound, such as a transition metal compound, and then fractionally distilling the phosphorus-containing compound. The fractional distillation provides at least two distillation fractions, one of which is collected at the boiling point of the phosphorus-containing compound being purified. Thus, the fractional distillation yields at least one fraction containing a phosphorus-containing compound with an arsenic level lower than the arsenic level of the phosphorus-containing compound before distillation. In various embodiments, the contacting with the at least one metal compound is carried out at an elevated temperature such as a reflux temperature. In a particular embodiment, the purified phosphorus-containing compound collected by fractional distillation has an arsenic level of about 20 ppb or less.

In another embodiment, the invention provides a method of purifying an arsenic-contaminated phosphorus-containing compound. The method comprises refluxing the arsenic-contaminated phosphorus-containing compound in the presence of at least one metal compound to provide a reflux mixture. Afterward a lower arsenic-contaminated phosphorus-containing compound may be separated from the reflux mixture by fractional distillation. The lower arsenic-contaminated compound collected by fractional distillation has an arsenic level less than that of the arsenic-contaminated phosphorus-containing compound. Without being bound by theory, it is believed that during refluxing the at least one metal compound reacts with an arsenic contaminant in the arsenic-contaminated compound or the at least one metal compound catalyzes redox reactions of arsenic in the phosphorus-containing compound. In a particular embodiment, the arsenic-contaminated phosphorus-containing compound before treatment has a level of arsenic above about 20 ppb, while the fraction collected by distillation contains about 20 ppb or less arsenic.

In a particular embodiment, a phosphorus-containing compound containing an undesirably high level of arsenic contamination, such as greater than about 20 ppb, is first treated with one or more metal compounds. Treatment is carried out by contacting the phosphorus-containing compound with the one or more metal compounds in any suitable form. Although it is possible to contact the phosphorus-containing compound with the one or more metal compounds in the form of wires, foils, and the like, it is preferred to carry out the treating step by stirring, agitating, or refluxing the phosphorus-containing compound in the presence of one or more metal compounds.

In a particular embodiment, the one or more metal compounds take the form of metal salts, metal oxides and/or metal sulfides. Examples include transition metal compounds such as transition metal salts, oxides and/or sulfides. In various embodiments, preferred transition metal salts include those of iron, cobalt, nickel, copper, and zinc. Examples include ferrous salts, cobaltous (cobalt II) salts, nickelous (nickel II) salts, and cuprous salts. In a particular embodiment, cuprous chloride (CuCl) is used. In another embodiment a metal sulfide such as ferrous sulfide (FeS) is used. In another embodiment, a metal oxide such as ferrous oxide (FeO) is used. In another embodiment, more than one transition metal compound can be used, such as a combination of two or more transition metal salts, oxides or sulfides, or a mixture of salts, oxides and/or sulfides. Although the invention is not limited by theory, it is noted that these salts, oxides or sulfides can behave as oxidizing agents, which may play a role in their interaction or reaction with arsenic contaminants in the phosphorus-containing compound.

Treatment with the at least one metal compound is carried out in a fashion and for a time sufficient to provide the benefits described herein. On a weight basis, a minor amount of metal compound can be used in proportion to the weight of the phosphorus-containing compound. Non-limiting ranges include 0.001 to 5% by weight, preferably 0.001-1% by weight. Illustrative treat levels of metal compound are thus in the ppm range, ranging form about 1 ppm up to about 100, 1000, or about 10,000 ppm. Higher levels can also be used, but are usually not required; such high levels are generally to be avoided, so as not to waste material.

In a particular embodiment, treatment is carried out at elevated temperatures. It is convenient to carry out the treatment during reflux of the phosphorus-containing compound prior to distillation. It has been found acceptable to treat with metal compound by refluxing for about one hour.

The refluxing temperature varies with the boiling point of the phosphorus-containing compound and with the pressure at which the refluxing is carried out. Typically, reflux is carried out at pressures between 0.01 atmospheres and 1 atmosphere, depending in part on the sensitivity of the phosphorus-containing compound to high temperatures. That is, if a phosphorus-containing compound tends to degrade or decompose at its atmospheric boiling point, it is possible to lower that boiling by carrying out the reflux at a lowered pressure. Suitable reflux conditions and boiling points of phosphorus-containing compounds at atmospheric pressure and at reduced pressures are readily available. See Aldrich® Catalogue 2007-2008, St. Louis, Mo.

Following the treatment with at least one metal compound, purified fraction(s) containing a phosphorus-containing compound, such as an organophosphorus compound, having a lower level of arsenic contamination (when compared to the phosphorus-containing compound before treatment, i.e. starting material) is collected by fractional distillation. Fractional distillation can be conveniently carried out in the same apparatus in which the refluxing is carried out when treating with the metal compound. Suitable fractional distillation columns are well known in the art. Fractional distillation is a unit process that separates materials from a mixture on the basis of differences in boiling points of the materials. Suitable fractional distillation columns and conditions are selected to provide the needed separation of the purified phosphorus-containing compound described herein. Suitable conditions are given for specific cases in the examples.

A purified fraction or fractions of the distilled phosphorus-containing compound are collected at the boiling point of the respective phosphorus-containing compound. Ordinarily, a volatile forecut fraction is collected first. A subsequent fraction or fractions is then collected at the boiling point or at the expected boiling point of the phosphorus-containing compound to be purified. The subsequent fraction(s) containing the purified phosphorus-containing compound, which is collected at the phosphorus-containing compound's normal boiling point, makes up a major part of the material collected by distillation (a.k.a. main fraction). Typically, more than 50% by weight of the purified phosphorus-containing compound is collected in the main fraction that boils at the boiling point of the phosphorus-containing compound. In some embodiments, about 10-15% of volatile forecut fraction is collected, 75% main fraction is collected, and 10% is left in the pot. The pot residue can have a very high concentration of metals so a main fraction is usually collected until the pot residue reaches at around 10%. In one example, the volatile forecut fraction contains around 65 ppb arsenic and the subsequent fraction(s) after this fraction has very low arsenic concentration, less than 20 ppb. Boiling point difference and GC purity does not indicate arsenic concentration and metal analysis is a sole source for detection of arsenic concentration. Typical results are given in the working examples.

In a particular embodiment, the invention provides a method of producing an organophosphorus compound, such as TEPO, that has about 20 ppb or less arsenic as a contaminant. The method involves refluxing TEPO in the presence of one or more metal compounds such as a salt, sulfide or oxide of iron, cobalt, nickel, copper, or zinc; and fractionally distilling the reflux mixture to collect a forecut fraction and a second fraction, wherein the second fraction is collected at the boiling point of TEPO. After distillation, the second fraction and optionally other fractions are isolated and combined to provide an organophosphorus compound, such as TEPO, that has an arsenic level at or below about 20 ppb. In a particular embodiment, the organophosphorus compound purified as an arsenic level of 20 ppb or less. In addition to producing purified TEPO, the method can be used to produce other purified organophosphorus compounds, such as without limitation a phosphate ester and/or phosphonate ester. Preferred materials for use in chip manufacturing include TEPO and TMPO.

### C. Purification with H₂O, Drying Agent, Neutralizing Agent

In another embodiment, the invention provides a method of reducing the level of arsenic in a phosphorus-containing compound (i.e. starting material). In this embodiment, the method involves pre-treating the phosphorus-containing compound starting material with water and afterward removing the water from the pre-treated mixture by combining the pre-treated mixture with a drying agent. The pre-treated mixture is then treated with a basic compound and distilled to collect at least one distillation fraction that contains a lower level of arsenic than that of the phosphorus-containing compound starting material. In one aspect, the method involves pre-treating the phosphorus-containing compound starting material with about 0.01% to about 5% by weight water, based on the weight of the phosphorus-containing compound. Advantageously, the pre-treating with water can be carried out at moderate temperatures, for example at a temperature below one at which a significant reaction with the phosphorus-containing compound takes place. For example, the pre-treating can be carried out at 50° C. or below and conveniently can be carried out at room temperature. In another aspect, pre-treating with water occurs at less than 100° C. (e.g. room temperature to 100° C. or 20-100° C.), less than 50° C. (e.g. room temperature to 50° C. or 20-50° C.), or about 20-30° C.

In some embodiments, it is observed that the fractional distillation produces a first fraction that is collected at a temperature below the boiling point of the phosphorus-containing compound and a second fraction that is collected at the boiling point of the phosphorus-containing compound.

In embodiments where the phosphorus-containing compound is purified by first pre-treating with water, contacting the phosphorus-containing compound with water occurs preferably at temperatures below a reflux temperature. As noted, contact with water occurs below 100° C., below 50° C., and preferably at around room temperature or between about 20° C. to about 30° C. The treatment with water can be carried out by gently stirring the phosphorus-containing compound with a minor amount of water, such as from about 0.01% to about 5% or from about 0.01% to about 0.5% by weight water. Illustrative treatment levels range from about 1 ppm up to about 10 ppm, 100 ppm, 1000 ppm or about 10000 ppm. The amount of water used is chosen to provide adequate treatment of the phosphorus-containing compound, but with not so much water that it cannot be removed by subsequent treatment with drying agents.

After treatment with water, the water is reduced in the mixture by adding a drying agent. Conventional drying agents can be used, such as magnesium sulfate, sodium sulfate, calcium chloride, calcium carbonate, barium oxide, sodium bicarbonate and the like.

After treatment with water and the drying agent, the reaction mixture is then treated with a basic compound. It is believed, without being bound by theory, that the basic compound might neutralize acidic arsenic species present in the phosphorus-containing compound or produced by reaction with water. Neutralization of the acidic components is believed to reduce their volatility so that fractional distillation recovers a phosphorus-containing compound having a lower level of arsenic than the phosphorus-containing compound before treatment, i.e. the starting material.

In a particular embodiment, the same compound or material is used as the drying agent and as the basic compound neutralizing agent. The compound or material is thus acting as a dual agent. In these cases the drying and neutralizing occur simultaneously. Non-limiting examples of such dual agents include sodium carbonate calcium carbonate, calcium hydroxide, sodium sulfate and barium oxide.

After treatment with water, drying agent, and neutralizing basic compound, the resulting treated reaction mixture is subjected to fractional distillation as described herein. Normally, a forecut (i.e. a first fraction) is collected and then a subsequent fraction(s) is collected. The forecut and subsequent fractions are collected at about the same temperature, i.e. about the boiling point of the phosphorus-containing compound. Advantageously, the purified fractions of the phosphorus-containing compound contain about 20 ppb or less arsenic. In a particular embodiment, the phosphorus-containing compound has 20 ppb or less arsenic.

### D. Chemical Intermediate

In another embodiment, a phosphorus-containing compound is purified, according to methods described herein, and then used as a chemical intermediate or reactant to synthesize a phosphorus-containing compound having a low level of arsenic, such as, without limitation, those described herein. Organophosphonates are generally made from a reaction of trialkyl phosphite P(OR)₃ with alkyl halide: P(OR)₃+R′X=R′P(O)(OR)₂+XR. For example, in a particular embodiment, an organophosphonate, such as POCl₃, is first purified by one of the methods described herein and then the purified POCl₃ is reacted with an alcohol such as ethanol (to make purified TEPO) or methanol (to make purified TMPO). The synthesized TEPO or TMPO thus has a lower level of arsenic contamination because the starting material, i.e. POCl₃, had been purified to a low level of arsenic contamination, such as about 20 ppb or lower. The method can be broadened to synthesize other phosphate esters and phosphonate esters by reacting suitable starting materials with suitable alcohols. In a particular embodiment, the synthesized TEPO or TMPO contains 20 ppb or less arsenic contamination.

### E. Discussion

Although the invention in various aspects is exemplified by the preparation of various organophosphorus compounds, it is believed that the methods are general to preparing or purifying any phosphorus-containing compound that can be subject to the reflux and fractional distillation conditions described herein. As noted, phosphorus ores from which commercial phosphorus-containing compounds are derived contain arsenic in at least trace levels as contaminants. In many applications it is desired to remove arsenic contaminants so as to purify the phosphorus-containing compound for further use. In various aspects, the phosphorus-containing compound is further used to synthesize a wide variety of phosphorus-containing compounds, such as organophosphorus compounds, or they are used directly as-purified in various applications such as chip manufacturing process.

Although the invention is not to be limited by theory, it is believed that treatment with the at least one metal compound or with water involves reaction with arsenic contaminants in the arsenic-contaminated phosphorus-containing compound and/or the catalysis of various redox reactions occurring in the arsenic-contaminated phosphorus-containing compound, with the result that arsenic species can be more readily separated from the reaction mixture by fractional distillation. In many embodiments, it is observed that a pure phosphorus-containing fraction containing a lower level of arsenic can be collected after first collecting a forecut fraction (i.e. a first fraction). The distillation fractions containing the purified phosphorus-containing compound can then be used directly in applications.

In a particular embodiment, the phosphorus-containing compound to be purified is an organophosphorus compound selected from TEPO and TMPO. The organophosphorus compound is treated with a metal compound and fractionally distilled as described herein, or is treated with water, dried, neutralized, and fractionally distilled as described herein. The result is a purified TEPO or TMPO containing a lower level of arsenic, such as 20 ppb or less, when compared to the TEPO or TMPO before treatment, i.e. the starting material.

### EXAMPLES

The invention has been described above with respect to various embodiments. Further non-limiting description is given in the examples that follow.

### Example 1

### Distillation of TEPO with Cu(I)Cl

A 50 L three-neck distillation flask is equipped with a 50 L heating mantle with built-in air-powered magnetic stirrer, 3-foot, silvered, vacuum jacketed distillation column packed with 0.24 in² Pro-Pak, and a fractional distillation head. After 42.5 kg of commercial TEPO and Cu(I)Cl (100 g) is charged into the distillation flask, a resulting green slurry is stirred around 1 h under a nitrogen stream to release the pressure that upon contact of CuCl with TEPO, might build up inside the distillation flask. With vigorous stirring, the distillation flask is refluxed for 24 h at 30-35 mmHg of the head pressure and head temperature goes up to 115° C. to 116° C. Slowly collect around 4.5 kg of volatile fraction to remove low boiling materials including ethanol that is azeotropic with TEPO (at 32 mmHg of the head pressure and head temperature goes up to 116-117° C.). Then, collect 33.4 Kg (78%) of main fraction that shows very low arsenic contamination and >99.0% GC purity (at 32 mmHg head pressure and 117° C. head temperature). Impurities concentration is very low (in a ppb range) so the temperature difference between fractions is very small.

TEPO samples are sent to Applied Analytical, Inc. (16713 Picadilly Court, Round Rock, Tex. 78664-8545) for ICP Mass test to report a full metal analysis including arsenic level.

Starting material (TEPO, Sigma-Aldrich® catalog No. 538728) contains 293 ppb arsenic.

Following purification using CuCl, no arsenic level is detected (detection limit is 4.6 ppb), 65 ppb for volatile fraction.

### Example 2

### Distillation of TEPO with Fe(II)S

A 2 L three-neck distillation flask is equipped with mechanical stirrer, 2-foot silvered, vacuum jacketed distillation column packed with 0.24 in² Pro-Pak, and a fractional distillation head. After charging 1.55 kg of commercial TEPO and Fe(II)S (15 g) is charged into the distillation flask, a resulting slurry is stirred around 1 h under a nitrogen stream to release the pressure that upon contact of FeS with TEPO, might build up inside the distillation flask. With vigorous stirring, the distillation flask is refluxed for 10 h at 30-35 mmHg of the head pressure and head temperature goes up to 115° C. to 116° C. Slowly collect around 162 g of volatile fraction to remove low boiling materials including ethanol that is azeotropic with TEPO (at 33 mmHg head pressure and 117-118° C. head temperature). Then, collect 1.0 Kg (65%) of main fraction that shows very low arsenic contamination and >99.0% GC purity (at 33 mmHg head pressure and 117-118° C. head temperature. Impurities concentration is very low (in a ppb range) so the temperature difference between fractions is very small.

TEPO samples are sent to Applied Analytical, Inc. (16713 Picadilly Court, Round Rock, Tex. 78664-8545) for ICP Mass test to report a full metal analysis including arsenic level.

Starting material (TEPO, Sigma-Aldrich® catalog No. 538728) contains 293 ppb arsenic.

Following purification using FeS, 37 ppb arsenic level is detected.

### Example 3

### Distillation of TEPO with Water and Sodium Sulfate

A 2 L multi-necked flask is equipped with mechanical stirrer and charged with TEPO (1000 mL) and DI Water (5 mL). A colorless solution is stirred for 6 h at room temperature, dried over anhydrous sodium sulfate (100.0 g) for 24 h and filtered via filter stick. The filtrate is fractionally distilled using 2-foot, silvered, vacuum jacketed distillation column packed with 0.24 in² Pro-Pak. Volatile fraction is collected around 145 g and main fraction 757 g (76%) that shows low arsenic contamination and >99.0% GC purity (at 27 mmHg. Both fractions were collected at 27 mmHg head pressure and 113-114° C. head temperature. Impurities concentration is very low (in a ppb range) so the temperature difference between fractions is very small.

TEPO samples are sent to Applied Analytical, Inc. (16713 Picadilly Court, Round Rock, Tex. 78664-8545) for ICP Mass test to report a full metal analysis including arsenic level.

Starting material (TEPO, Sigma-Aldrich® catalog No. 538728) contains 293 ppb arsenic.

Following purification using H₂O/Na₂SO₄, no arsenic level is detected (detection limit 15 ppb).

All patents and publications cited herein are incorporated by reference into this application in their entirety.

The words “comprise”, “comprises”, and “comprising” are to be interpreted inclusively rather than exclusively.

1. A method of purifying a starting material, wherein the starting material is an organophosphorus-containing compound having an arsenic contaminate, the method comprising:
contacting the starting material with at least one metal compound to provide a mixture; then
fractionally distilling the mixture to provide at least two distillation fractions; and
collecting at least one distillation fraction containing an organophosphorus-containing compound having less arsenic contaminate than the starting material.

2. The method according to claim 1, wherein contacting is carried out at a reflux temperature of the organophosphorus-containing compound.

3. The method according to claim 1, wherein the at least one metal compound is a transition metal compound comprising an iron compound, cobalt compound, nickel compound, copper compound, or a zinc compound.

4. The method according to claim 3, wherein the at least one transition metal compound comprises a ferrous compound or a cuprous compound.

5. The method according to claim 3, wherein the at least one transition metal compound comprises FeS, FeO, or CuCl.

6. The method according to claim 1, wherein the organophosphorus-containing compound is selected from the group consisting of triethyl phosphate, trimethyl phosphate, triisopropyl phosphate, tri-n-propyl phosphate, tributyl phosphate; dimethyl methylphosphonate, diethyl methylphosphonate, diisopropyl methylphosphonate, dibutyl methylphosphonate, dimethyl ethylphosphonate, diethyl ethylphosphonate, diisopropyl ethylphosphonate and dibutyl ethylphosphonate.

7. The method according to claim 1, wherein the organophosphorus-containing compound is triethyl phosphate.

8. The method according to claim 1, wherein the organophosphorus-containing compound having less arsenic contaminate than the starting material has about 20 ppb or lower arsenic contaminate.

9. A method of synthesizing a phosphate ester having about 20 ppb or less arsenic, comprising purifying POCl₃ by a method comprising
contacting POCl₃ with at least one metal compound to provide a mixture;
fractionally distilling the mixture to provide at least two distillation fractions;
collecting at least one distillation fraction containing the purified POCl₃, and reacting the purified POCl₃ with an alcohol to make the phosphate ester.

10. The method according to claim 9, wherein the phosphate ester is triethyl phosphate or trimethyl phosphate.

11. A method of purifying a starting material, wherein the starting material is an arsenic-contaminated organophosphorus-containing compound, the method comprising
refluxing the starting material in the presence of at least one metal compound to provide a reflux mixture;
whereby an organophosphorus-containing compound having lower arsenic contamination than the starting material may be separated from the reflux mixture by fractional distillation.

12. The method according to claim 11, wherein the at least one metal compound comprises an iron compound, a cobalt compound, a nickel compound, a zinc compound, or a copper compound.

13. The method according to claim 11, wherein the at least one metal compound comprises FeO, FeS, or CuCl.

14. The method according to claim 11, wherein the starting material contains greater than 20 ppb arsenic and the organophosphorus-containing compound having lower arsenic contamination than the starting material contains about 20 ppb or less arsenic.

15. The method according to claim 14, wherein the starting material is selected from the group consisting of a phosphonate ester and a phosphate ester.

16. The method according to claim 11, wherein the starting material is triethyl phosphate or trimethyl phosphate.

17. A method of synthesizing a phosphate ester having about 20 ppb or less arsenic, comprising purifying POCl₃ by a method comprising
refluxing POCl₃ in the presence of at least one metal compound to provide a reflux mixture;
separating the purified POCl₃ from the reflux mixture by fractional distillation and reacting the purified POCl₃ with an alcohol to make the phosphate ester.

18. The method according to claim 17, wherein the phosphate ester is triethyl phosphate or trimethyl phosphate.

19. A method of purifying an organophosphorus-containing compound having greater than about 20 ppb arsenic, the method comprising:
refluxing the organophosphorus-containing compound in the presence of at least one transition metal compound selected from the group consisting of iron salt, cobalt salt, nickel salt, copper salt, zinc salt, iron oxide and iron sulfide to provide a reflux mixture;
fractionally distilling the reflux mixture to collect a low boiling fraction as a forecut and a second fraction, wherein the second fraction is collected at the boiling point of the organophosphorus-containing compound; and
isolating the second fraction and optionally combining it with other fractions to provide an organophosphorus-containing compound having about 20 ppb or less arsenic.

20. The method according to claim 19, comprising refluxing the organophosphorus-containing compound in the presence of a cuprous salt.

21. The method according to claim 19, comprising refluxing the organophosphorus-containing compound in the presence of a ferrous salt.

22. The method according to claim 19, wherein the organophosphorus-containing compound is refluxed in the presence of cuprous chloride, ferrous oxide, or ferrous sulfide.

23. The method according to claim 19, wherein the organophosphorus-containing compound is selected from the group consisting of phosphate ester and phosphonate ester.

24. The method according to claim 19, wherein the organophosphorus-containing compound is triethyl phosphate or trimethyl phosphate.

25. The method according to claim 19, comprising refluxing for about an hour before distilling.

26. A method of reducing arsenic in a starting material, wherein the starting material is a phosphorus-containing compound, the method comprising:
pre-treating the starting material with water to make a mixture;
removing water from the mixture by combining the mixture with a drying agent;
treating the mixture with a basic compound; and
distilling the mixture to collect at least one distillation fraction that contains a phosphorus-containing compound having a lower arsenic than the starting material.

27. The method according to claim 26, comprising pre-treating with about 10 ppm to about 10,000 ppm water, based on the weight of the phosphorus-containing compound.

28. The method according to claim 26, wherein the drying agent and the basic compound are the same, and the removing step and the treating step are carried out simultaneously.

29. The method according to claim 26, wherein distilling produces a first fraction collected at a temperature below the boiling point of the phosphorus-containing compound and a subsequent fraction collected at the boiling point of the phosphorus-containing compound.

30. A method according to claim 26, wherein the phosphorus-containing compound is triethyl phosphate or trimethyl phosphate.

31. A method according to claim 26, comprising recovering the phosphorus-containing compound having lower arsenic than the starting material from the distillation, wherein the phosphorus-containing compound having lower arsenic than the starting material contains about 20 ppb or less of arsenic.

32. The method according to claim 26, comprising pre-treating with water at a temperature below about 100° C.

33. The method according to claim 26, comprising pre-treating with water at a temperature below about 50° C.

34. The method according to claim 26, comprising pre-treating with water at a temperature of about 20° C. to about 30° C.
